(19) United States
(12) Patent Application Publication
(10) Pub. No.: US 2015/0181003 A1
(43) Pub. Date: Jun. 25, 2015

(54) METHOD AND APPARATUS FOR TRANSMITTING AND RECEIVING PACKETS IN HYBRID TRANSMISSION SERVICE OF MMT

(71) Applicant: Electronics and Telecommunications Research Institute, Daejeon (KR)

(72) Inventors: Chang Ki Kim, Daejeon (KR); Jeong Ju Yoo, Daejeon (KR); Jin Woo Hong, Daejeon (KR); Kwang Deok Seo, Wonju-si Gangwon-do (KR)

(21) Appl. No.: 14/413,494

(22) PCT Filed: Jun. 10, 2013
(86) PCT No.: PCT/KR2013/005086

§ 371 Date: Jan. 8, 2015

(30) Foreign Application Priority Data
Jul. 10, 2012 (KR) 10-2012-0074984
May 2, 2013 (KR) 10-2013-0049304

(51) Int. Cl. H04L 29/06; H04L 7/00

(52) U.S. Cl. CPC H04L 69/22; H04L 69/28; H04L 7/0008

(57) ABSTRACT

The present invention relates to an apparatus for transmitting packets in an MPEG Media Transport (MMT) system, including: an MMT packetizing unit recording standard time information related to a media access unit for providing synchronization of the media access unit and generating MMT packets; and a transmission unit transmitting the generated MMT packets to the recipient side. Accordingly, synchronization between different media can be provided in a hybrid transmission environment where media streams belonging to one program are transmitted from different servers.

### TECHNICAL FIELD

The present invention concerns packet transmission and receiving apparatuses and methods, and more specifically, to packet transmission and receiving apparatuses and methods for providing media sync in a hybrid transmission-based MMT (MPEG Media Transport) service.

### BACKGROUND ART

MMT (MPEG Media Transport) is new transmission standard technology that has been undertaken for its development by an MPEG system sub-working group.

In particular, the hybrid transmission-based MMT service utilizes different servers so that a plurality of media data can be delivered to a single client device through different channels or networks. In such case, the client device needs to be able to service the plurality of received media streams with the media streams synced with one another in the integrated form. This may not be satisfied by existing syncing schemes, such as MPEG-2 system DTS (Decoding Timestamp), PTS (Presentation Timestamp), or PCR (Program Clock Reference)-based timing models or RTP timestamp-based timing models. The media synching scheme that is now under development in the MMT may support sync between media streams generated by the same server, but fails to provide exact sync between streams transmitted from different servers in a hybrid environment.

In case a plurality of media data is delivered from different servers in a heterogeneous network environment, the DTS, PTS, and PCR-based timing models provided in the conventional MEPG-2 system, when applied to such a case, may exhibit the following problems. DTS, PS, and PCR clock values all are generated to be consistent with local STCs (System Time Clocks) adopted by a specific transmission server. If DTS, PTS, and PCR clock values for a media stream are generated based on a local STC of server A, and DTS, PTS, and PCR clock values for another stream that needs to be synced with the media stream are generated based on a local STC of server B, there is no time information that may be commonly utilized by the streams generated from the different servers using different STCs. Accordingly, the MPEG-2 system timing model cannot sync the streams generated and transmitted from different servers with each other.

The RTP (Real-Time Transport Protocol)-based transmission service may provide sync between real-time media streams by using the RTP timestamp and NTP (Network Time Protocol) timestamp. However, the RTP-based transmission service is based on utilizing NTP timestamp information generated while a real-time service is underway, and thus, it is, as the matter of fact, impossible to sync the media data that has been already stored in the storage of the server with another stream that is being serviced in real time by other server. An NTP timestamp value generated by the RTP represents a reference time (wall-clock) corresponding to a sampling time for a media sample that is input in real time to the encoder and the NTP timestamp value has a fixed length of 64 bits. This NTP timestamp value is periodically delivered from the server to a client separately over an RTCP SR (Real-Time Transport Control Protocol Sender Report) packet in the out-of-band scheme. The NTP time information being periodically delivered in the out-of-band scheme may cause a waste of network bandwidth, and since the server and the client need to open a separate port to process the RTCP SR packet stream, may result in a waste of port together with its implementation being more complicated.

### DISCLOSURE

### Technical Problem

To address the above-described problems, an object of the present invention is to provide a packet transmission and receiving apparatus and method in an MMT hybrid transmission service that suggests time information necessary for providing sync between media transmitted from different servers in an MMT protocol-based hybrid environment and records the information in MMT-CI (Composition Information) or MPU (Media Processing Unit) header part of E-layer.

### Technical Solution

To achieve the above-described objects, according to the present invention, an apparatus of transmitting a packet in an MMT (MPEG Media Transport) system may comprise an MMT packetizing unit generating an MMP packet by recording standard time information relating to a media access unit (AU) to provide sync of the media access unit and a transmitting unit transmitting the generated MMT packet to a receiver.

The MMT packetizing unit may generate the MMT packet by recording standard time information corresponding to a PTS (Presentation TimeStamp) of a media access unit included in the MMT packet.

The MMT packetizing unit may generate the MMT packet by recording in a header or composition information (MMT-CI: MMT Composition Information) of a media processing unit standard time information corresponding to a PTS value on a per-MPU (Media Processing Unit) basis, wherein the MPU is generated by encapsulating the media access unit.

The standard time information may be UTC (Universal Time Coordiated) time information corresponding to a PTS value possessed by a first access unit among a plurality of media access units included in the media processing unit.

The media processing unit does not allocate the standard time information to every media processing unit, and upon allocation, adjusts a frequency of allocation of the standard time information depending on sync accuracy.

An NTP (Network Time Protocol) format may be used to represent the standard time information.

The media processing unit may vary the length of the NTP timestamp according to a resolution of the UTC time or sync accuracy when representing the standard time information in the NTP format.

The length of the NTP timestamp may be at least any one of 32 bits, 48 bits, and 64 bits.

The MMT packet may be transmitted in an in-band scheme.

Whether the standard time information is generated may be determined by judging whether a transmission environment is a hybrid transmission environment in which media streams are transmitted and received from different servers respectively belonging to different (heterogeneous) networks.

In an environment in which reference video information and additional video information generated by multi-view video coding are transmitted from different servers, respectively, the standard time information may be included in an MMT packet including video information generated by the multi-view video coding and is transmitted.

The header or composition information of the media processing unit may include information relating to whether to generate the standard time information, resolution information of the NTP timestamp for representing the standard time information and actual standard time information according to the resolution.

To achieve the above-described objects, according to the present invention, a method of transmitting a packet in an MMT (MPEG Media Transport) system may comprise an MMT packetizing step of generating an MMP packet by recording standard time information relating to a media access unit (AU) to provide sync of the media access unit and a transmitting step of transmitting the generated MMT packet to a receiver.

To achieve the above-described objects, according to the present invention, an apparatus of receiving a packet in an MMT (MPEG Media Transport) system may comprise a receiving unit receiving an MMT packet from a sender and an MMT de-packetizing unit de-packetizing the MMT packet and syncing a media access unit (AU) included in the MMT packet based on standard time information relating to the media access unit to provide sync of the media access unit.

The MMT de-packetizing unit may comprise a de-packetizing unit obtaining the standard time information included in a header or composition information (MMT-CI) of a media processing unit generated by de-packetizing the MMT packet and a syncing unit performing sync on the media access unit based on the obtained standard time information.

The apparatus may further comprise a reproducing unit reproducing the synced media access unit.

The standard time information may be UTC (Universal Time Coordiated) time information corresponding to a PTS value possessed by a first access unit among a plurality of media access units included in the media processing unit.

The header or composition information of the media processing unit may include information relating to whether to generate the standard time information, resolution information of the NTP timestamp for representing the standard time information and actual standard time information according to the resolution.

The length of the NTP timestamp to represent the standard time information may be at least any one of 32 bits, 48 bits, and 64 bits depending on sync accuracy or resolution of UTC time.

To achieve the above-described objects, according to the present invention, a method of receiving a packet in an MMT (MPEG Media Transport) system may comprise a receiving step receiving an MMT packet from a sender and an MMT de-packetizing step de-packetizing the MMT packet and syncing a media access unit (AU) included in the MMT packet based on standard time information relating to the media access unit to provide sync of the media access unit.

### Advantageous Effects

The packet transmission and receiving apparatus and method in an MMT hybrid transmission service according to the present invention may provide sync between different media in a hybrid transmission environment in which media streams are transmitted from different servers although belonging to a single program.

### DESCRIPTION OF DRAWINGS

FIG. 1 is a conceptual view illustrating an MMT layer structure.

FIG. 2 illustrates the format of unit information (or data or a packet) used in each layer of an MMT layer structure as shown in FIG. 1.

FIG. 3 is a block diagram illustrating a system architecture for an MMT hybrid transmission service.

FIG. 4 is a block diagram schematically illustrating a configuration of an MMP packet transmitting apparatus according to an embodiment of the present invention.

FIG. 5 is a flowchart schematically illustrating an MMT packet transmission method according to an embodiment of the present invention.

FIG. 6 is a concept view illustrating an example in which a sync information generating unit of an MMT packet transmitting apparatus according to an embodiment of the present invention generates UTC information based on the PTS of a first AU of an MPU.

FIG. 7 is a concept view illustrating an example in which an MMT packet transmitting apparatus according to an embodiment of the present invention stores generated UTC information in an MPU header or MMT-CI.

FIG. 8 is a block diagram illustrating an example of providing a 3D video service based on multi-view videos received from different servers using an MMT packet transmission method according to an embodiment of the present invention.

FIG. 9 is a block diagram schematically illustrating a configuration of an MMT packet receiving apparatus according to an embodiment of the present invention.

FIG. 10 is a detailed block diagram illustrating an MMT de-packetizing unit 920 of an MMT packet receiving apparatus according to an embodiment of the present invention.

FIG. 11 is a flowchart illustrating an MMT packet receiving method according to an embodiment of the present invention.

### BEST MODE

Hereinafter, as used herein, the terms are defined as follows.

The “content component” or “media component” is defined as a single type of media or a subset of a single type of media, and may include, e.g., a video track, a movie subtitle, or an enhancement layer of a video.

The “content” is defined as a set of content components, and may include, e.g., a movie or a song.

The “presentation” is defined as an operation performed by one or more devices so that a user may experience one content component or one service (for example, watching movie).

The “service” is defined as one or more content components transmitted for a presentation or storage.

The “service information” is defined as meta data describing one service, characteristics of the service, and components.

The “access unit (AU)” is a smallest data medium, and the access unit may have time information as its attribute.

When encoded media data involves that is not designated with time information for decoding and presentation, no AU is defined.

The MMT asset is a logical data medium that consists of the same MMT asset ID and at least one MPU or consists of a specific data clump together with a format defined in other standards. The MMT asset is a largest data unit that is applied with the same composition information and transmission characteristic.

The MMT asset delivery characteristic (MMT-ADC) is a description related to a QoS request for transmitting the MMT asset. The MMT-ADC is expressed not to be aware of a specific transmission environment.

The MMT composition information (MMT CI) describes a spatial and temporal relationship between MMT assets.

The media fragment unit (MFU) is a general container independent from any specific codec and accommodates encoded media data that may be independently consumable by a media decoder. The MFU has a size equal to or smaller than the access unit (AU) and accommodates information that may be used in the transmission layer.

The MMT package is a collection of logically structured data and consists of at least one MMT asset, MMT-composition information, MMT-asset transmission characteristics, and descriptive information.

The MMT packet is the format of data generated or consumed by an MMT protocol.

The MMT payload format is the format for the payload of an MMT signaling message or MMT package delivered by an MMT protocol or Internet applicable layer protocol (e.g., RTP).

The MMT processing unit is a general container independent from any specific media codec and accommodates at least one AU and information associated with additional transmission and consumption. For non-temporal data, the MPU accommodates data part that does not belong to the AU range. The MPU is encoded media data that may be processed completely and independently. In this sense, the “process” means encapsulation or packetization into the MMT package for transmission.

The non-timed data defines all data elements that are consumed with no time specified. The non-timed data may have a temporal range when data may be executed or started.

The timed data defines data elements associated with a specific time when decoding and presentation are done.

Hereinafter, preferred embodiments of the present invention will be described in detail with reference to the accompanying drawings. For better understanding of the present invention, the same reference denotations are used to refer to the same elements throughout the drawings, and repetitive description of the same elements is skipped.

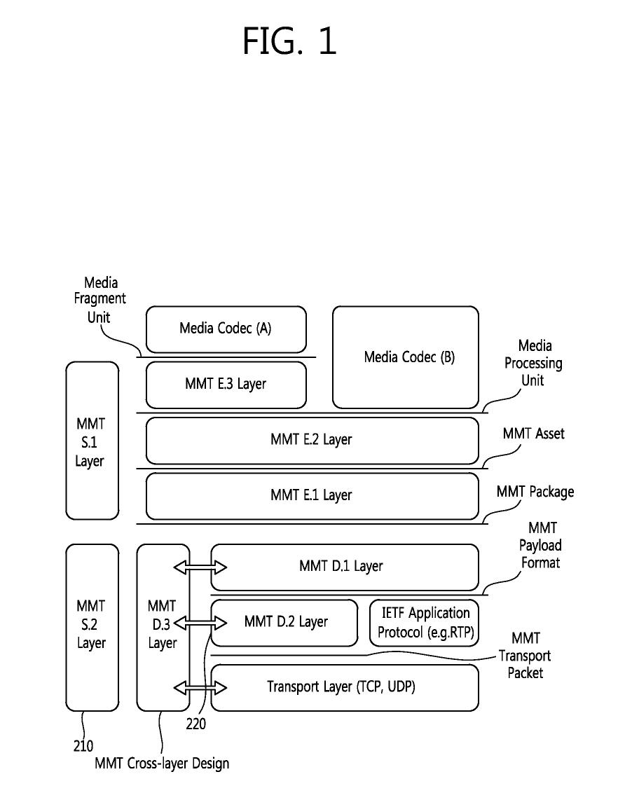

FIG. 1 is a conceptual view illustrating an MMT layer structure.

Referring to FIG. 1, the MMT layer includes an encapsulation layer, a delivery layer, and an S layer. The MMT layer operates over a transport layer.

The encapsulation layer (E-layer) may be in charge of functions such as, for example, packetization, fragmentation, synchronization, and multiplexing of transmitted media.

The encapsulation functional area defines the logical structure of the format of data units that are processed by a medium observing MMT, an MMT package, and media content. In order to provide information necessary for adaptive transmission, the MMT package specifies components including media content and the relationship therebetween. The format of the data units is defined to encapsulate encoded media so as to be stored or transmitted by the payload of transmission protocol and to be easily transformed therebetween.

The encapsulation layer (E-layer), as shown in FIG. 1, may include an MMT E. 1 layer, an MMT E.2 layer, and an MMT E.3 layer.

The E.3 layer encapsulates a media fragment unit (MFU) provided from the media codec A to generate a media processing unit (MPU).

Media data encoded from a higher layer is encapsulated into an MFU. The type and value of the encoded media may be abstracted so that the MFU may be generally used in specific codec technology. This enables a lower layer to be able to process the MFU without access to the encapsulated, encoded media. The lower layer calls requested media data out of a buffer of a network or storage and transmits it to a media decoder. The MFU has an information media part unit enough to perform the above-described operation.

The MFU may have a format independent from any specific codec, which may load a data unit independently consumable in the media decoder. The MFU may be, e.g., a picture or slice of a video.

One or a group of multiple MFUs that may be independently transmitted and decoded generate MPUs. Non-timed media that may be independently transmitted and executed also generate MPUs. The MPU describes an inner structure such as arrangement and pattern of the MFU that enables partial consumption and rapid access to the MFU.

The E.2 layer encapsulates the MPU generated in the E.3 layer and generates an MMT asset.

The MMT asset is a data entity consisting of one or more MPUs from a single data source and is a data unit that defines composition information (CI) and transport characteristics (TC). The MMT asset is multiplexed by an MMT payload format and is transmitted by an MMT protocol. The MMT asset may correspond to a PES (Packetized Elementary Stream). For example, the MMT asset may correspond to, for example, a video, an audio, program information, an MPEG-U widget, a JPEG image, an MPEG 4 file format, or an M2TS (MPEG transport stream).

The E.1 layer encapsulates the MMT asset generated in the E.2 layer and generates an MMT package.

The MMT asset is packaged with MMT composition information (MMT-CI) for the same user experienced future response separately from or together with other functional regions-transmission region and signal region. The MMT package is also packaged with transmission characteristics that pick a transmission scheme proper for each MMT asset to satisfy the felt quality of the MMT asset.

The MMT package may consist of one or more MMT assets together with side information such as composition information and transmission characteristics. The composition information includes information on a relationship between MMT assets, and in case one content includes a plurality of MMT packages, the composition information may further include information to represent a relationship between the plurality of MMT packages. The transmission characteristics may include transmission characteristic information necessary for determining a delivery condition of the MMT asset or MMT packet. For example, the transmission characteristics may include a traffic description parameter and a QoS descriptor. The MMT package may correspond to the program of MPEG-2 TS.

The delivery layer may perform, e.g., network flow multiplexing, network packetization, and QoS on media transmitted through a network.

The delivery functional area defines the application layer protocol and format of a payload. The application layer protocol according to the present invention provides enhanced characteristics for delivery of MMT packages as compared with the conventional application layer protocol for transmission of multimedia including multiplexing. The payload format is defined to deliver encoded media data irrespective of media type or encoding scheme.

The delivery layer (D-layer), as shown in FIG. 1, may include an MMT D.1 layer, an MMT D.2 layer, and an MMT D.3 layer.

The D.1 layer receives an MMT package generated in the E.1 layer and generates an MMT payload format. The MMT payload format is a payload format for transmitting an MMT asset and transmitting information for consumption by other existing application transmission protocol such as MMT application protocol or RTP. The MMT payload may include a fragment of an MFU together with information such as AL-FEC.

The D.2 layer receives an MMT payload format generated in the D.1 layer and generates an MMT transport packet or an MMT packet. The MMT transport packet or MMT packet have a data format used in an application transmission protocol for MMT.

The D.3 layer supports QoS by providing the function of being able to exchange information between layers by cross-layer design. For example, the D.3 layer may perform QoS control using the QoS parameter of MAC/PHY layers.

The S layer performs a signaling function. For example, the S layer may perform signaling functions for session initialization/control/management of transmitted media, a server-based and/or client-based trick mode, service discovery, and synchronization.

The signaling functional area defines the format of a message that manages delivery and consumption of an MMT package. The message for consumption management is used to transport the structure of the MMT package, and the message for delivery management is used to transport the structure of a payload format and the configuration of a protocol.

The S layer, as shown in FIG. 1, may include an MMT S.1 layer and an MMT S.2 layer.

The S.1 layer may conduct functions such as service discovery, media session initialization/termination, media session presentation/control, and interfacing with a delivery (D) layer and encapsulation (E) layer. The S.1 layer may define the format of control messages between applications for media presentation session management.

The S.2 layer may define the format of a control message exchanged between delivery end-points of delivery layer (D-layer) regarding flow control, delivery session management, delivery session monitoring, error control, and hybrid network synchronization control.

The S.2 layer may include signaling for adaptive delivery, signaling for synchronization under a complex delivery environment, resource reservation for a configured delivery session, error control, flow control, delivery session monitoring, delivery session establishment and release in order to support the operation of a delivery layer. The S.2 layer may provide signaling necessary between a sender and a receiver. In other words, the S.2 layer may provide signaling necessary between the sender and the receiver so as to support the operation of a delivery layer as described above. Further, the S.2 layer may be responsible for interfacing with a delivery layer and an encapsulation layer.

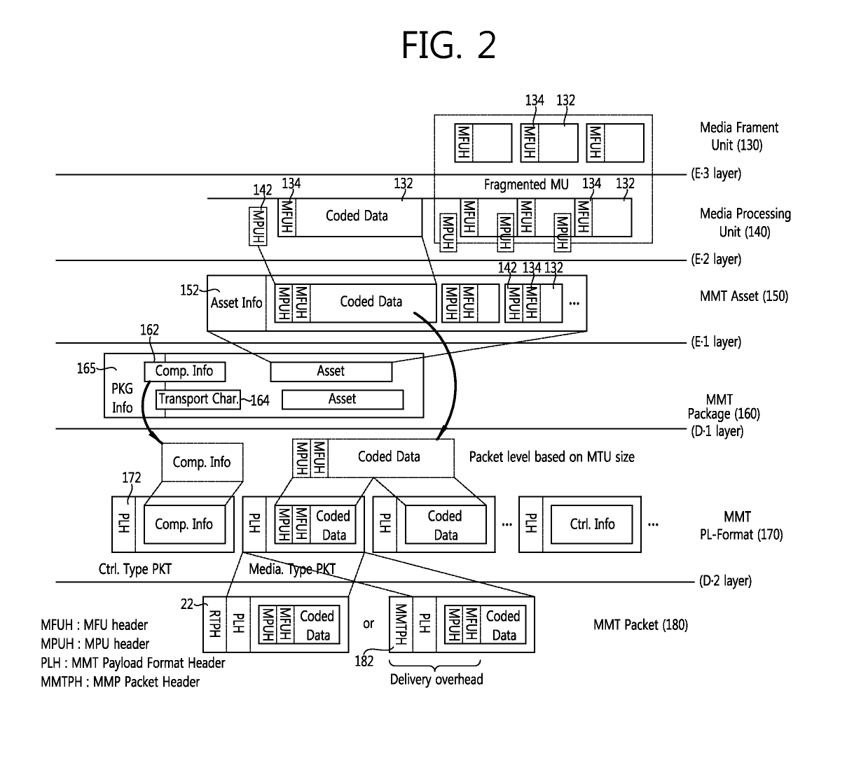

FIG. 2 illustrates the format of unit information (or data or a packet) used in each layer of an MMT layer structure as shown in FIG. 1.

The media fragment unit (MFU) 130 may include encoded media fragment data 132 and an MFUH (Media Fragment Unit Header) 134. The MFU 130 has a general container format independently from a specific codec and may load the smallest data unit as independently consumable in a media decoder. The MFUH 134 may include side information such as media characteristics—for example, loss-tolerance. The MFU 130 may be, e.g., a picture or slice of a video.

The MFU may define a format in which part of an AU is encapsulated in a transport layer to perform adaptive transmission in a range of the MFU. The MFU may be used to transport a predetermined format of encoded media so that part of an AU may be independently decoded or discarded.

The MFU has an identifier for distinguishing one MFU from the other MFUs and may have information on a general relationship between MFUs in a single AU. The relationship in dependency between the MFUs in the single AU may be described, and a related priority order of MFUs may be described with part of such information. The above information may be used to treat transmission in a lower transport layer. For example, the transport layer may skip transmission of MFUs that may be discarded so as to support QoS transmission in an insufficient bandwidth. The detailed description of the MFU structure is described below.

The MPU is a set of media fragment units including a plurality of media fragment units 130. The MPU may have a general container format independently from a specific codec and may include media data equivalent to an access unit. The MPU may have a timed data unit or a non-timed data unit.

The MPU is data independently and completely processed by a medium following the MMT, and such process may include encapsulation and packetization. The MPU may include at least one MFU or may have part of data having a format defined by other standards.

A single MPU may accommodate non-timed data or an integral number of at least one AU. For timed data, the AU may be delivered from at least one MFU, but one AU may not be split into multiple MPUs. In the non-timed data, one MPU accommodates part of non-timed data independently and completely processed by a medium observing the MMT.

The MPU may be uniquely identified in an MMT package by a sequence number and an associated asset ID that distinguishes the MPU from other MPUs.

The MPU may have at least one arbitrary access point. A first byte of the MPU payload may always start with the arbitrary access point. In the timed-data, the above fact means that in the MPU payload, the priority in decoding order of the first MFU is always 0. In the timed-data, the presentation period and decoding order of each AU may be sent to inform the presentation time. The MPU does not have its initial presentation time, and the presentation time of the first AU in one MPU may be described in the composition information. The composition information may specify the first presentation time of the MPU. Detailed description will be given below.

The MMT asset 150 is a set of a plurality of MPUs. The MMT asset 150 is a data entity consisting of multiple MPUs (timed or non-timed data) from a single data source, and the MMT asset information 152 includes side information asset packaging metadata and data type. The MMT asset 150 may include, e.g., a video, an audio, program information, an MPEG-U widget, a JPEG image, an MPEG 4 FF (File Format), a PES (Packetized Elementary Stream), and an M2TS (MPEG transport stream).

The MMT asset is a logical data entity that accommodates encoded media data. The MMT asset may consist of an MMT asset header and encoded media data. The encoded media data may be a collective reference group of MPUs with the same MMT asset ID. Data of a type that may be individually consumed by an entity directly connected to an MMT client may be considered an individual MMT asset. Examples of the data type that may be considered an individual MMT asset may include MPEG-2 TS, PES, MP4 file, MPEG-U Widget Package, and JPEG file. The encoded media of the MMT asset may be timed data or non-timed data.

The timed data is audio-visual media data that requires synced decoding and presentation of specific data at a designated time. The non-timed data may be data of a type that may be decoded and provided at any time depending on provision of a service or users' interaction.

The service provider may generate a multimedia service by integrating the MMT assets and putting the MMT assets on spatial-temporal axes.

The MMT package 160 is a set of MMT assets that include one or more MMT assets 150. The MMT assets in the MMT package may be multiplexed or concatenated like a chain.

The MMT package has a container format for configuration information and an MMT asset. The MMT package provides storage of the MMT asset and configuration information for an MMT program.

The MMT program provider generates configuration information by encapsulating encoded data into MMT assets and describing the temporal and spatial layouts of the MMT assets and their transmission characteristics. The MU and MMT asset may be directly transmitted in the D.1 payload format. The configuration information may be transmitted by the C.1 presentation session management message. However, the MMT program provider and client that allow relay or future reuse of the MMT program store this in the MMT package format.

In parsing the MMT package, the MMT program provider determines a transmission path (for example, broadcast or broadband) along which the MMT asset is provided to the client. The configuration information in the MMT package, together with transmission-related information, is transmitted to the C.1 presentation session management message.

The client receives the C.1 presentation session management message and is aware of what MMT program is possible and how the MMT asset for the corresponding MMT program is received.

The MMT package may be transmitted by the D.1 payload format as well. The MMT package is packetized into the D.1 payload format and is delivered. The client receives the packetized MMT package and configures part or whole thereof, and here consumes the MMT program.

The package information 165 of the MMT package 160 may include configuration information. The configuration information may include side information such as a list of MMT assets, package identification information, composition information, and transmission characteristics 164. The composition information 162 includes information on a relationship between the MMT assets 150.

Further, the composition information 162, in case one content consists of a plurality of MMT packages, may further include information for representing a relationship between the plurality of MMT packages. The composition information 162 may include information on a temporal, spatial, and adaptive relationship in the MMT package.

Like information assisting in transmission and presentation of the MMT package, the composition information in the MMT provides information for a spatial and temporal relationship between MMT assets in the MMT package.

MMT-CI is descriptive language expanding HTML5 and providing information. While HTML5 has been designed to describe a text-based content page-based presentation, MMT-CI primarily represents a spatial relationship between sources. To support an expression that informs a temporal relationship between MMT assets, expansion may be made to have information associated with the MMT asset that is included in the MMT package like presentation resources, time information for determining the order of transmission and consumption of MMT assets and additional attributes of media elements that consume various MMT assets in HTML5. A detailed description will be described below.

The transmission characteristic information 164 includes information on transmission characteristics and may provide information necessary to determine transmission conditions of each MMT asset (or MMT package). The transmission characteristic information may include a traffic description parameter and a QoS descriptor.

The traffic description parameter may include priority information and bit rate information on the media fragment unit (MFU) 130 or MPU. The bit rate information may include, e.g., information on whether the MMT asset has a variable bit rate (VBR) or constant bit rate (CBR), a guaranteed bit rate for the media fragment unit (MFU) (or MPU), and a maximum bit rate for the media fragment unit (MFU) (or MPU). The traffic description parameter may be used for resource reservation between a server, a client, and other constituent elements on a delivery path, and may include, e.g., information on the maximum size of the media fragment unit (MFU) (or MPU) in the MMT asset. The traffic description parameter may be periodically or a periodically updated.

The QoS descriptor may include information for QoS control, e.g., delay information and loss information. The loss information may include, e.g., a loss indicator indicating whether the delivery loss of the MMT asset is acceptable. For example, the loss indicator being ‘1’ denotes lossless′, and the loss indicator being ‘0’ denotes lossy.′ The delay information may include a delay indicator used to indicate the sensitivity of a transport delay of the MMT asset. The delay indicator may indicate whether the type of the MMT asset is conversation, interactive, real time or non-real time.

One content may consist of one MMT package. Or, one content may consist of a plurality of MMT packages.

In case one content consists of a plurality of MMT packages, composition information or configuration information indicating temporal, spatial, and adaptive relationships between the plurality of MMT packages may be present inside one of the MMT packages or outside the MMT packages.

For example, in the case of hybrid delivery, some of the content components may be transmitted through a broadcast network while the others of the content components may be transmitted through a broadband network. For example, in the case a plurality of AV streams constituting one multi-view service, one stream may be transmitted through a broadcast network, another stream may be transmitted through a broadband network, and each AV stream may be multiplexed and individually received and stored by a client terminal. Or, by way of example, there may be a scenario in which application software such as widgets may be transmitted through a broadband network, and AV streams (AV programs) may be transmitted through an existing broadcast network.

In the case of the above-described multi-view service scenario and/or widget scenario, all of the plurality of AV streams may become one MMT package. In such case, one of the plurality of streams may be stored in only one client terminal and storage content becomes part of the MMT package. The client terminal should re-record composition information or configuration information, and the re-recorded content becomes a new MMT package that is not related to a server.

In the case of above-described multi-view scenario and/or widget scenario, each AV stream may become one MMT package. In such case, the plurality of MMT packages constitutes one content. Recording is performed on a per-MMT package basis in the storage. Composition information or configuration information indicating a relationship between the MMT packages is needed.

The composition information or configuration information included in one MMT package may refer to the MMT asset in other MMT package. The outside of the MMT package may be represented that refers to the MMT package under the out-band circumstance.

Meanwhile, in order to inform the client terminal of a path available for delivery of the MMT package 160 and a list of MMT assets 160 provided by the service provider, the MMT package 160 is translated into service discovery information through the control (C) layer, so that the MMT control message may include an information table for service discovery.

The server that splits multimedia content into a plurality of segments allocates URL information to the plurality of segments and stores URL information for each segment in a media information file and transmits the media information file to the client.

The media information file may be referred to by various terms, such as ‘media presentation description (MPD)’ or ‘manifest file’ depending on the standardization organization that standardizes HTTP streaming. Hereinafter, the media information file, upon its description, is referred to as media presentation description (MPD).

Hereinafter, a cross layer interface is described.

The cross layer interface (CLI) exchanges QoS-related information between a lower layer including MAC/PHY layers and an application layer and provides a means for supporting QoS in a single entity. The lower layer provides upstream QoS information such as a network channel condition while the application layer provides information relating to media characteristics as downstream QoS information.

The cross layer interface provides an integrated interface between various network layers including IEE802.11 WiFi, IEEE 802.16 WiMAX, 3G, or 4G LTE and an application layer. Common network parameters in popular network standards are quoted as NAM parameters for static and dynamic QoS control of real-time media applications that pass through various networks. The NAM parameters may include a BER value that is a bit error rate. The BER may be measured in the PHY or MAC layer. Further, the NAM provides identification of a lower network, a possible bit rate, a buffer status, a peak bit rate, a service unit size, and a service data unit loss rate.

Two different methods may be used to provide the NAM. The first method is to provide an absolute value. The second method is to provide a relative value. The second method may be used for the purpose of updating the NAM while on access.

The application layer provides downstream QoS information related to media characteristics for a lower layer. There are two types of downstream information such as MMT asset level information and packet level information. The MMT asset information is used for capacity exchange and/or resource (re)allocation at the lower layer. The packet level downstream information is recorded in a proper field of each packet for the lower layer to identify a supported QoS level.

The lower layer provides upstream QoS information to the application layer. The lower layer provides information relating to a network status that varies according to times when more correct QoS control may be possible. The upstream information is expressed in an abstract manner so as to support a heterogeneous network environment. Such parameters are measured in the lower layer and are read in the application layer periodically or upon request from the MMT application.

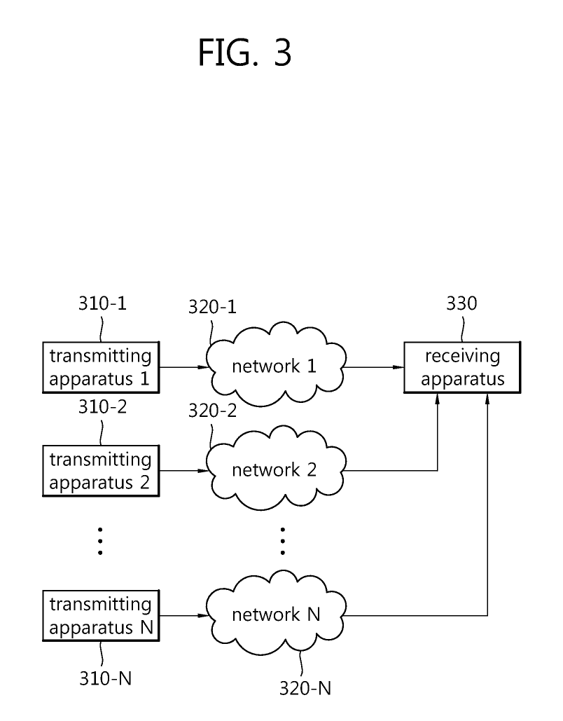

FIG. 3 is a block diagram illustrating a system architecture for an MMT hybrid transmission service. As shown in FIG. 3, the MMT hybrid transmission system may include transmitting apparatuses 310-1, 310-2, . . . , and 310-N, networks 320-1, 320-2, . . . , and 320-N, and a receiving apparatus 330.

Referring to FIG. 3, there may be a plurality of transmitting apparatuses 310-1, 310-2, . . . , and 310-N. The transmitting apparatuses 310-1, 310-2, . . . , and 310-N generate video, voice, and data information and transmit the information to a receiver. For example, the transmitting apparatuses 310-1, 310-2, . . . , and 310-N each may generate content such as video, voice, and data, so that transmitting apparatus 1 310-1 may transmit video information to the receiver through a network of the networks 320-1, 320-2, . . . , and 320-N and transmitting apparatus 2 310-2 may transmit voice information to the receiver through another network of the networks 320-1, 320-2, . . . , and 320-N. The transmitting apparatuses 310-1, 310-2, . . . , and 310-N each may be a broadcast station. The transmitting apparatuses 310-1, 310-2, . . . , and 310-N may transmit media streams or MMT packets through the same network or through different networks from each other.

There may be a plurality of networks 320-1, 320-2, . . . , and 320-N. For example, network 1 320-1 may be a broadcast network, and network 2 320-2 may be a communication network. As the types of the networks 320-1, 320-2, . . . , and 320-N are different from each other, there may be a difference in the amount of network jitter or delay, and accordingly, there may be a difference in time of arrival at the receiver with respect to one AV source. That is, the networks 320-1, 320-2, . . . , and 320-N perform sync to comply with the same reference with a reference time set in the same network, while in case media streams are transmitted through different networks 320-1, 320-2, . . . , and 320-N, there may be a discrepancy in the reference time, thus resulting in sync being impossible at the receiver.

The receiving apparatus 330 may receive media streams or MMT packets transmitted through different networks 320-1, 320-2, . . . , and 320-N. However, the media streams or MMP packets are not necessarily transmitted through different networks 320-1, 320-2, . . . , and 320-N. For example, with respect to the same AV source, the video information may be received from the transmitting apparatus 310-1 through the network 1 320-1, and voice information may be received through the transmitting apparatus 310-2 through the network 2 320-2. The receiving apparatus 330 may be a terminal that may perform wireless or wired communication.

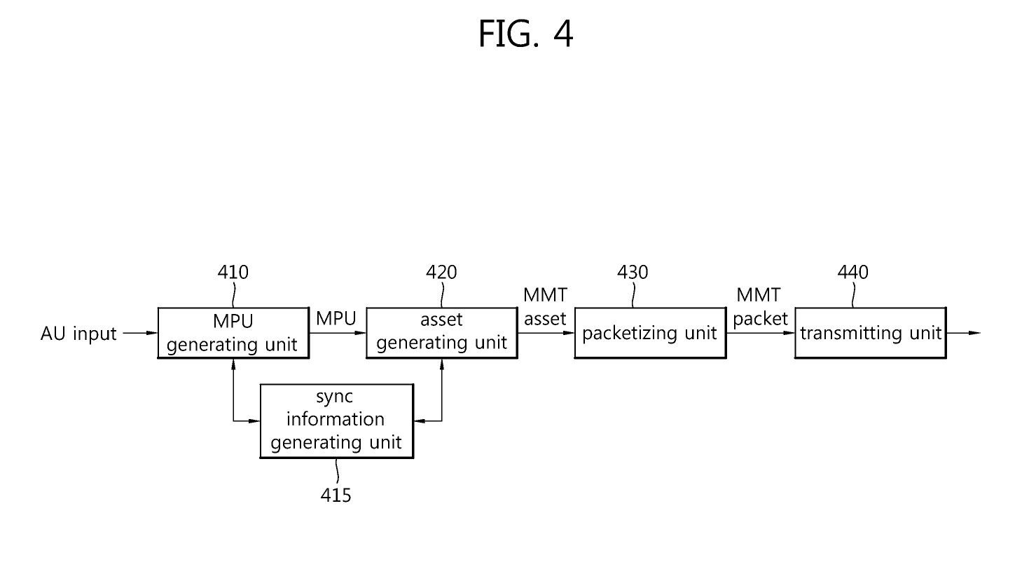

FIG. 4 is a block diagram schematically illustrating a configuration of an MMP packet transmitting apparatus according to an embodiment of the present invention. As shown in FIG. 4, the MM packet transmitting apparatus according to an embodiment of the present invention may include an MPU generating unit 410, a sync information generating unit 415, an asset generating unit 420, a packetizing unit 430, and a transmitting unit 440.

Referring to FIG. 4, the MPU generating unit 410 generates a media processing unit (MPU) based on a media access unit (AU). The process of generating the media processing unit in the MPU generating unit 410 may be performed in an E-layer through encapsulation.

The sync information generating unit 415 generates UTC (Universal Time Clock) time information corresponding to the PTS value of the media access unit (AU) included in the generated MPU. Here, it is not inevitable to use the UTC time information, and other standard time information that may be used as a reference for different networks may also be used. The UTC is a criterion for standard time that is used in a number of countries all around the world and is provided through various channels such as a general telephone network, Internet, a satellite communication system, and a satellite navigation system. Accordingly, according to an embodiment of the present invention, the UTC time may be obtained by a computing device directly connected with the above-listed equipment to supply the UTC. The UTC time may be represented in the form of a timestamp. At this time, a standard protocol format, NTP (Network Time Protocol), may be used. The NTP may be well used for performing sync between networks, and the NTP is a standard protocol that is adopted and used for the RTP protocol. However, the NTP time information used for the current RTP is the one obtained by expressing in the NTP format timestamp the time of the wall-clock corresponding to the RTP timestamp value read by a local clock at the moment that the access unit (AU) data of audio and video is sampled (captured) by an encoder. This NTP time information is separately included in the RTCP SR (Sender Report) packet and is periodically delivered from the server to the client in the out-of-band scheme. In case the NTP time information is periodically delivered in the out-of-band scheme, the network bandwidth may be wasted. Further, the server and the client need open a separate port to process the RTCP SR packet stream, resulting in the waste of ports and increased complexity in implementation.

Accordingly, the sync information generating unit 415 of the MM packet transmitting apparatus according to an embodiment of the present invention may generate the UTC time information for each MPU generated in the MPU generating unit 410 as the timing information of the E-layer of the MMT. At this time, the generated UTC time may be recorded in the MMT-CI or in the header of the MPU and may be transmitted to the client in the in-band scheme, so that media sync may be achieved with a small amount of data and reduced complexity in the hybrid transmission.

The sync information generating unit 415 may generate the UTC time information by extracting the UTC time corresponding to the PTS of the first access unit (AU) among a plurality of media access units (Aus) included in the MPU. The UTC time information may mean a reference clock (wall clock) value corresponding to the PTS value possessed by the first access unit (AU) among several access units (Aus) included in all the media processing unit (MPU) data. However, the UTC time information is not necessarily allocated to all the media processing units (MPUs), and considering sync accuracy, the frequency in which the UTC time information is allocated may be adjusted. That is, in case the sync accuracy is high, the UTC time information is generated for each and every access unit (AU), and in case the sync accuracy is relatively low, one UTC time information may be generated every two or three access units (Aus).

At this time, the length of the generated UTC time information may vary depending on the sync accuracy or resolution of the UTC time. The UTC time information generated in the sync information generating unit 415 may be represented in the NTP format. According to an embodiment of the present invention, when representing the UTC, the NTP format is used, which does not have a fixed length of 64 bits that is adopted in the existing RTP scheme but has various NTP timestamp lengths depending on the sync accuracy as required.

The asset generating unit 420 generates an MMT asset by performing encapsulation based on the media processing unit (MPU) generated in the MPU generating unit 410. At this time, the UTC time information generated in the sync information generating unit 415 may be inserted into the MPU header or MMT-CI, generating an MMT asset.

The packetizing unit 430 generates an MMT packet by packetizing the MMT asset generated in the asset generating unit 420. The packetizing unit 430 may generate an MMT package based on a plurality of MMT assets and MMT-CI and transmission characteristic information and may generate an MMT packet based on the generated MMT package.

The transmitting unit 440 transmits the generated MMP packet to the receiver.

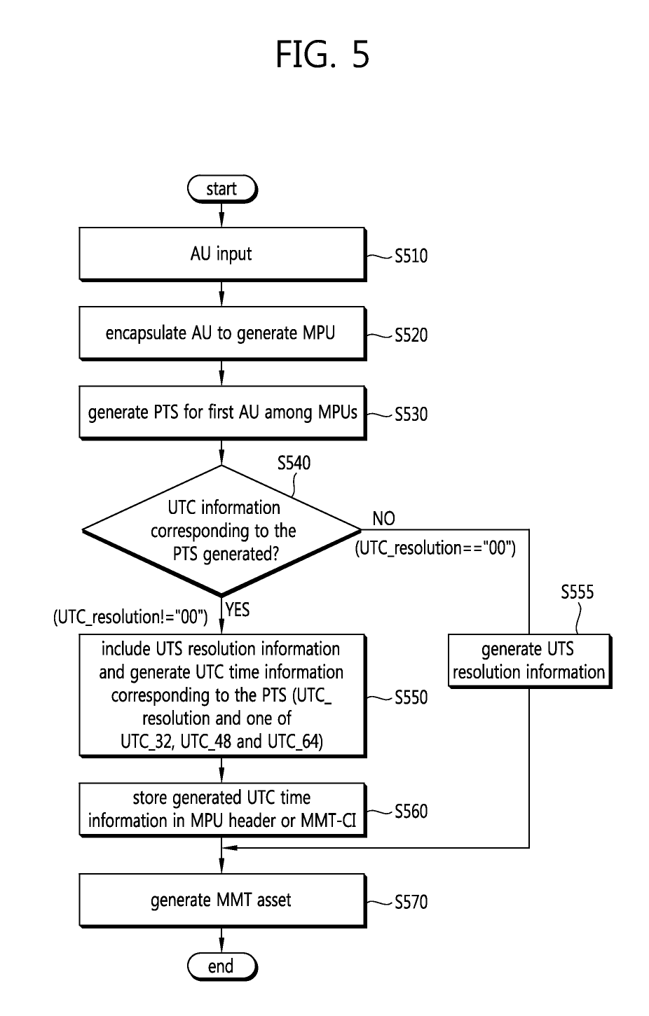

FIG. 5 is a flowchart schematically illustrating an MMT packet transmission method according to an embodiment of the present invention.

Referring to FIG. 5, the MMT packet transmitting apparatus may receive a media access unit (AU) (S510). The media access unit (AU) may include information relating to video, voice, and data and may be information to be synced with an access unit (AU) transmitted from other devices. After the access unit (AU) is input, the MMT packet transmitting apparatus generates a media processing unit (MPU) by encapsulating the media access unit (AU) (S520). Then, the MMT packet transmitting apparatus generates a PTS for the first media access unit (AU) among media access units (Aus) included in the media processing unit (MPU) (S530). At this time, the generated PTS information is generated by a local clock of the MMT packet transmitting apparatus. Accordingly, there may be a gap between the clock time and the local clock of the MMT packet transmitted through another network. The MMT packet transmitting apparatus determines whether to generate UTC information corresponding to the PTS (S540). For example, the MMT packet transmitting apparatus looks into the network environment and determines whether it corresponds to the hybrid transmission environment in which media streams are transmitted/received to/from different servers (or devices) respectively belonging to different types of (heterogeneous) networks. In case a result of the determination shows the hybrid transmission environment, UTC time information is needed, so that UTC information is determined to be generated. Otherwise, in the case of the transmission environment in which media streams are transmitted through the same network, without generating UTC time information, sync may be achieved only with the time information generated by the local clock.

The MMT packet transmitting apparatus may include information relating to whether to generate UTC time information in the UTC resolution information (UTC_resolution) and may transmit it to the receiver. In case the UTC resolution information is “00,” no UTC information is generated, and it is determined that no UTC information is included in the time-related information of the MMT packet. In case the UTC resolution information is not “00,” it may be determined that UTC information has been generated and is included in the MMT packet and transmitted. In case no UTC information is generated, i.e., when the UTC resolution information is “00,” UTC resolution information representing that the UTC resolution is “00” is generated (S555), and without a separate process of inserting time information relating to the actual UTC, the media processing unit (MPU) may be immediately encapsulated, thereby generating an MMT asset (S570).

In case UTC information is generated, as described above, it includes UTC resolution information, and UTC time information corresponding to the PTS of the first access unit (AU) of the media processing unit (MPU) is generated (S550). At this time, the NTP timestamp bit length of the UTC time information may be at least any one of 32, 48, and 64. Then, the MMT packet transmitting apparatus may store the generated UTC time information in the header or MMT-CI of the media processing unit (MPU) (S560). The UTC time information need not be stored in the header or MMT-CI of the MPU, and rather may be stored in other parts of the MMT packet. Then, the MMT packet transmitting apparatus generates an MMT asset by encapsulating the media processing unit (MPU) (S570).

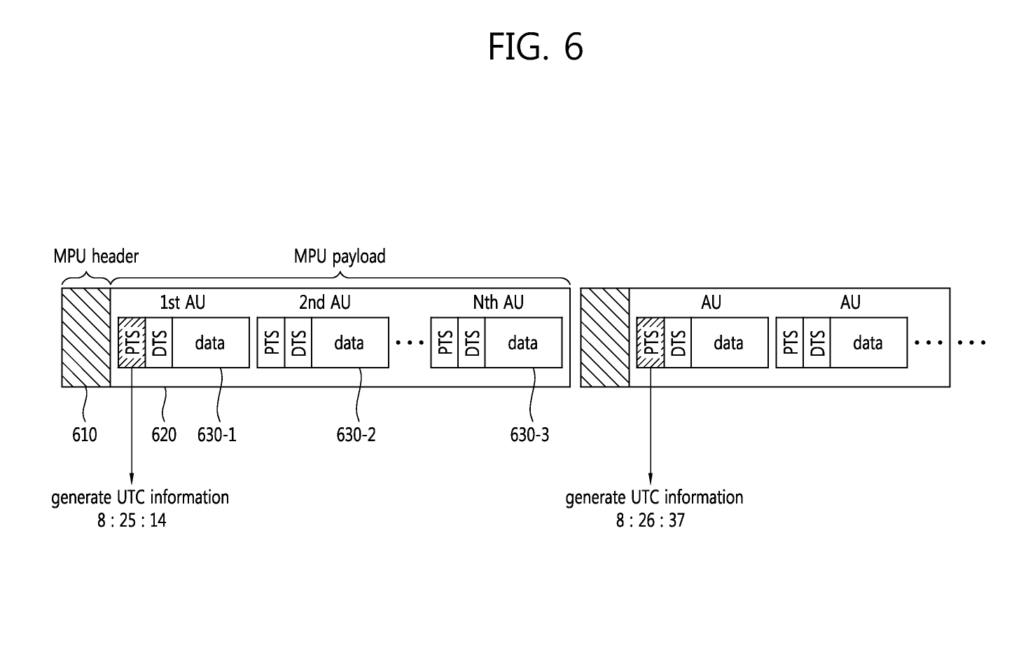

FIG. 6 is a concept view illustrating an example in which a sync information generating unit of an MMT packet transmitting apparatus according to an embodiment of the present invention generates UTC information based on the PTS of a first AU of an MPU.

Referring to FIG. 6, the media processing unit (MPU) may include an MPU header 610 and an MPU payload 620. The MPU header 610 includes information relating to the data belonging to the MPU payload. The MPU payload 620 may include a plurality of access units 630-1, 630-2, . . . , and 630-N. Each of the access units 630-1, 630-2, . . . , and 630-N may include PTS information and DTS information.

The UTC time information generated according to an embodiment of the present invention may be generated based on the PTS information of the first access unit 630-1 among the plurality of access units 630-1, 630-2, . . . , and 630-N belonging to the media processing unit (MPU). That is, the UTC time information may be generated based on the UTC corresponding to the PTS of the first access unit 630-1. The PTS information for the second or subsequent access units (AUs) may be obtained through a difference in PTS time between the access units (AUs) based on the UTC time information of the first access unit (AU). According to an embodiment of the present invention, the UTC time information may be allocated on a per-media processing unit (MPU) basis. In other words, after UTC time information is generated corresponding to the PTS of the first access unit (AU) of the ith media processing unit (MPU), the UTC time information corresponding to the PTS of the first access unit (AU) of the i+1th media processing unit (MPU) may be generated. However, UTC time information need not be allocated to all the media processing units (MPUs), and depending on sync accuracy or UTC time accuracy, the frequency in which the UTC time information is allocated to the media processing unit (MPU) may be determined. Accordingly, the information may be recorded in the header or MMT-CI of the media processing unit (MPU) data generated by the sender at a predetermined period and may be transmitted to the receiver.

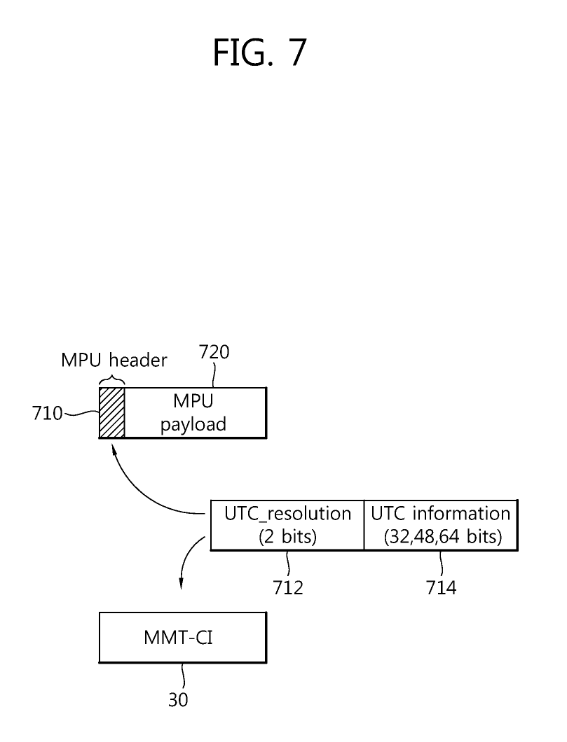

FIG. 7 is a concept view illustrating an example in which an MMT packet transmitting apparatus according to an embodiment of the present invention stores generated UTC information in an MPU header or MMT-CI.

Referring to FIG. 7, the MMT packet transmitting apparatus may include UTC time information in the MPU header 710 or MMT-CI 730. The UTC time information may resolution information 712 (UTC_resolution) and actual UTC information 714 of the UTC time information. Here, the actual UTC information 714 (at least any one of UTC_{—}32, UTC_{—}48, and UTC_{—}64) may be expressed in the length of 32, 48 and 64 bits. Here, the resolution information 712 of the UTC time information needs to be included, and whether to include the actual UTC information 714 may be determined based on the resolution information 712. At this time, an NTP timestamp format is used to represent the UTC time information. According to an embodiment of the present invention, a fixed length of 64 bits as in the prior art is not used, and an NTP timestamp length of 32 bits, 48 bits, or 64 bits may be selectively used.

Table 1 below shows syntax for UTC time information recorded in the header of MMT MPU data:

TABLE 1

| | | |
|---|---|---|
| | No. Of | |
| Syntax | bits | Mnemonic |

MPU_Header( ){

...

| | |
|---|---|
| UTC_resolution | 2 |
| if (UTC_resolution:=00) { | |
| if (UTC_resolution=01) | |

| | |
|---|---|
| UTC_32; | 32 |

else if(UTC_resolution==10)

| | |
|---|---|
| UTC_48; | 48 |

else if(UTC_resolution==11)

| | |
|---|---|
| UTC_64; | 64 |

}
...

}
MPU_Payload( )

Here, UTC-resolution may be represented in two bits, and refers to the resolution of an NTP timestamp for expressing a UTC time. In case the value is “00,” no UTC time information exists. In case the value is “01,” the resolution of the NTP timestamp for representing the UTC time is 32 bits. In case the value is “10,” the resolution of the NTP timestamp for representing the UTC time is 48 bits. In case the value is “01,” the resolution of the NTP timestamp for representing the UTC time is 64 bits.

UTC_{—}32 means a value obtained by representing the UTC time information corresponding to the PTS time of the first access unit (AU) of the media processing unit (MPU) in a 32-bit NTP timestamp. UTC_{—}48 means a value obtained by representing the UTC time information corresponding to the PTS time of the first access unit (AU) of the media processing unit (MPU) in a 48-bit NTP timestamp. Likewise, UTC_{—}64 means a value obtained by representing the UTC time information corresponding to the PTS time of the first access unit (AU) of the media processing unit (MPU) in a 64-bit NTP timestamp.

At this time, in case the 32-bit NTP timestamp is used (UTC_{—}32), it may split into a 16-bit integer sec-based represented section and a 16-bit decimal point sec-based represented section. In case the 48-bit NTP timestamp is used (UTC_{—}48), it may split into a 16-bit integer sec-based represented section and a 32-bit decimal point sec-based represented section. In case the 64-bit NTP timestamp is used (UTC_{—}64), it may split into a 32-bit integer sec-based represented section and a 32-bit decimal point sec-based represented section. As such, the resolution of the NTP timestamp is selectively applied depending on the required UTC time accuracy, so that the bit length required for the NTP timestamp value may be significantly reduced. In the case of the current RTP, the length of the NTP timestamp remains fixed to 64 bits, so that a lot of bits are wasted for expressing the NTP timestamp. However, according to an embodiment of the present invention, such waste of bits may be remarkably reduced.

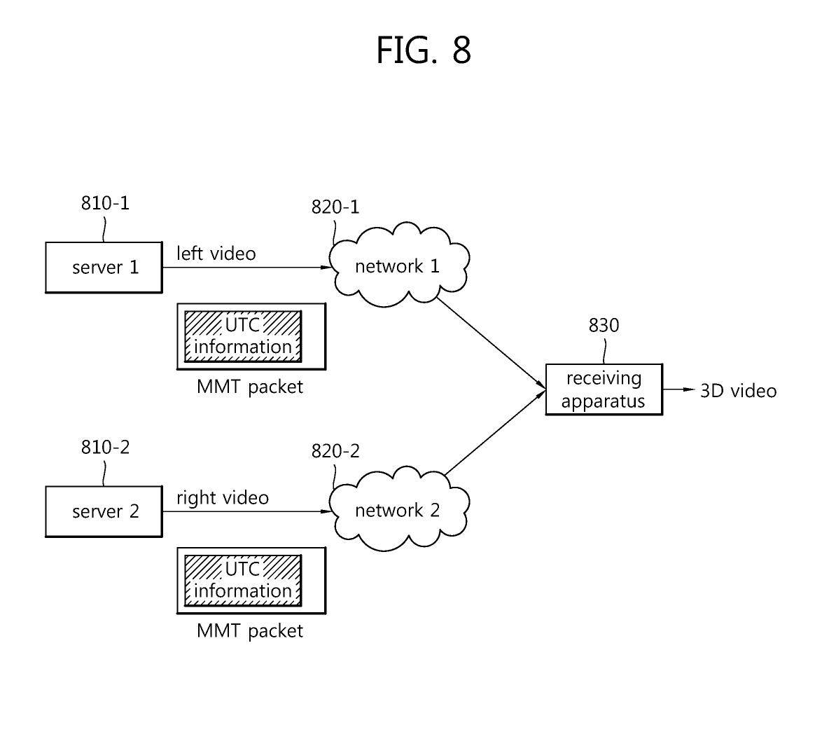

FIG. 8 is a block diagram illustrating an example of providing a 3D video service based on multi-view videos received from different servers using an MMT packet transmission method according to an embodiment of the present invention.

Referring to FIG. 8, multi-view videos generated by multi-view video coding may be transmitted to a receiving apparatus 830 from different servers 810-1 and 810-2 through different networks 820-1 and 820-2. In such case, UTC time information according to the present invention may be inserted into each segment of video information for media sync. That is, server 1 810-1 may transmit video information relating to a left video through a broadcast network, and server 2 810-2 may transmit through a communication network video information relating to a right video for, together with the left video, generating a 3D video. At this time, since video information is transmitted through the different networks, a discrepancy in the reference of the local clock may occur, thus rendering it difficult for the receiving apparatus 830 to render the 3D video. However, in case according to the present the MMT packet is transmitted of having the UTC time information recorded in the MPU heard or MMT-CI, the UTC for the access unit (AU) associated with the right and left videos of the 3D video that is supposed to be played back at the same time is displayed in the same way in the different networks, and thus, exact sync may be achieved in the receiving apparatus 830. Accordingly, even in the hybrid transmission environment in which the reference video and additional video are transmitted from different servers, a 3D video may be displayed on the screen with exact sync established between the reference video and the additional video.

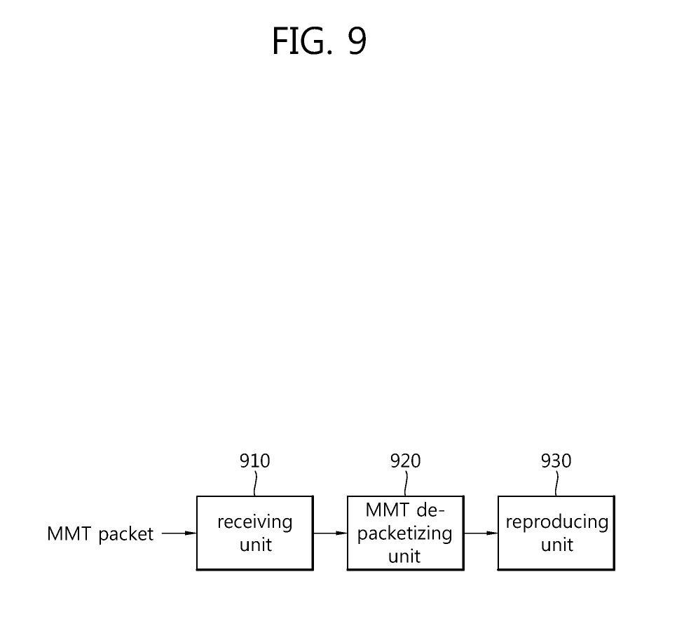

FIG. 9 is a block diagram schematically illustrating a configuration of an MMT packet receiving apparatus according to an embodiment of the present invention. As shown in FIG. 9, the MMT packet receiving apparatus according to an embodiment of the present invention may include a receiving unit 910, an MMT de-packetizing unit 920, and a reproducing unit 930.

Referring to FIG. 9, the receiving unit 910 receives an MMT packet. The receiving unit 910 may receive MMT packets transmitted through networks different from each other.

The MMT de-packetizing unit 920 de-packetizes the MMT packet received by the receiving unit 910 and performs sync of a media access unit (AU) included in the MMT packet based on the UTC time information relating to the media access unit (AU). The UTC time information may be included in the header or MMT-CI of the media processing unit (MPU) of the received MMT packet, and the MMT de-packetizing unit 920 may obtain the UTC time information by parsing the header or MMT-CI of the media processing unit (MPU). The UTC time information may be information associated with the UTC time corresponding to the PTS value owned by the first access unit (AU) among a plurality of access units (AUs) included in the media processing unit (MPU). Accordingly, despite the difference in reference time, region, and type between networks, the UTC time applies in the same way, so that sync may be conducted using the UTC time information. The UTC time information may be represented in the NTP timestamp format and may include at least any one of the resolution information of the NTP timestamp and standard time information according to the resolution. The length of the NTP timestamp may be at least any one of 32, 48, and 64 bits depending on sync accuracy or resolution of UTC time.

In case the received MMT packet has been received through the same network or through a local clock system having the same reference, media sync may be achieved only with the PTS information. However, sync between MMT packets received through local clock systems having their respective different references may not be achieved only with the PTS information that is local clock-based time information. Accordingly, sync between media access units (AUs) may be achieved using the UTC time information.

The reproducing unit 930 reproduces the media access unit (AU) that has been synced by the MMT de-packetizing unit 920 in synchronization with another.

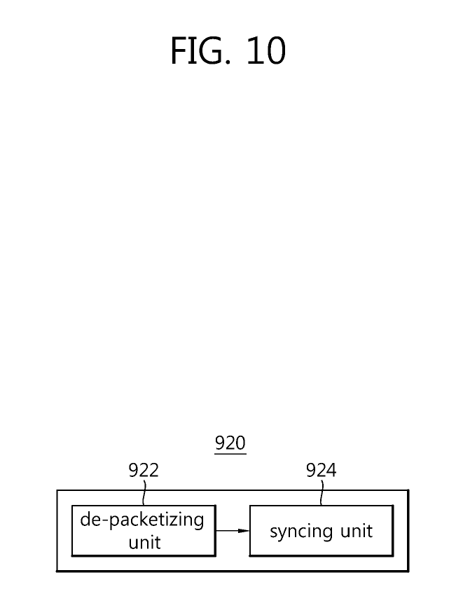

FIG. 10 is a detailed block diagram illustrating an MMT de-packetizing unit 920 of an MMT packet receiving apparatus according to an embodiment of the present invention. As shown in FIG. 10, the MMT de-packetizing unit 920 according to an embodiment of the present invention may include a de-packetizing unit 922 and a syncing unit 924.

Referring to FIG. 10, the MMT de-packetizing unit 920 generates the access unit (AU) by de-packetizing the MMT packet. In other words, the MMT de-packetizing unit 920 generates the MMT package by de-packetizing the MMT packet and de-capsulates the MMT package to thereby generate the MMT asset, de-capsulates the MMT asset to generate the media processing unit (MPU), and generates the access unit (AU) based on the media processing unit (MPU). At this time, the MMT de-packetizing unit 920 may obtain the UTC time information included in the header or MMT-CI of the generated media processing unit (MPU). However, since the UTC time information is not included for each and every media processing unit (MPU), the MMT de-packetizing unit 920 may figure out whether there is UTC time information by referring to the UTC resolution information (UTC_resolution). The MMT de-packetizing unit 920, in case there is UTC time information, grasps the bit length of the actual UTC information based on the UTC resolution information and obtains the UTC time corresponding to the PTS for the first access unit (AU) of the media processing unit (MPU) through as much bit information as the grasped length. However, since the UTC time information is not present in the header of all the media processing units (MPUs), whether there is UTC time information should be grasped based on the UTC resolution information. The MMT de-packetizing unit 920 may obtain the UTC time information for the first access unit (AU) of each media processing unit (MPU), and based on the obtained UTC time information, may also produce UTC time information for other access units (AUs) using a difference between PTSs. By such a process, the UTC time information corresponding to the PTS for each access unit (AU) may be obtained.

The MMT de-packetizing unit 920 performs sync on the media access units (AUs) of the MMT packets received from the different transmitting apparatuses based on the obtained UTC time information.

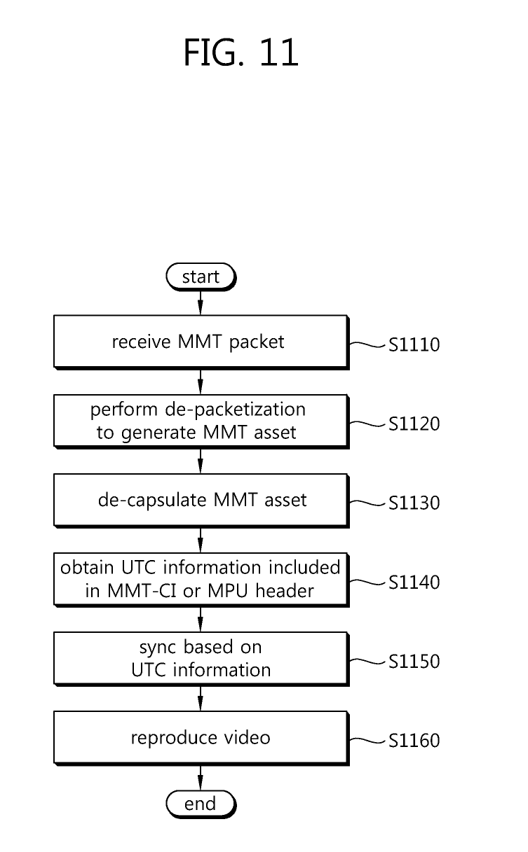

FIG. 11 is a flowchart illustrating an MMT packet receiving method according to an embodiment of the present invention.

Referring to FIG. 11, the MMT packet receiving apparatus receives an MMT packet (S1110). The MMT packet receiving apparatus then generates an MMT asset by de-packetizing the received MMT packet (S1120). The MMT packet receiving apparatus then de-capsulates the generated MMT asset (S1130). Thereafter, the MMT packet receiving apparatus obtains the UTC time information included in the header of the media processing unit (MPU) or MMT-CI (S1140). Next, the MMT packet receiving apparatus performs sync on each access unit (AU) based on the obtained UTC time information. At last, the MMT packet receiving apparatus reproduces the access unit (AU) in synchronization with another (S1160).

Although embodiments of the present invention have been described, it will be understood by those of ordinary skill in the art that various modifications or changes may be made thereto without depart from the scope of the invention as defined in the appended claims.

1. An apparatus of transmitting a packet in an MMT (MPEG Media Transport) system, the apparatus comprising:
an MMT packetizing unit generating an MMP packet by recording standard time information relating to a media access unit (AU) to provide sync of the media access unit; and
a transmitting unit transmitting the generated MMT packet to a receiver.

2. The apparatus of claim 1, wherein the MMT packetizing unit generates the MMT packet by recording standard time information corresponding to a PTS (Presentation TimeStamp) of a media access unit included in the MMT packet.

3. The apparatus of claim 2, wherein the MMT packetizing unit generates the MMT packet by recording in a header or composition information (MMT-CI: MMT Composition Information) of a media processing unit standard time information corresponding to a PTS value on a per-MPU (Media Processing Unit) basis, wherein the MPU is generated by encapsulating the media access unit.

4. The apparatus of claim 3, wherein the standard time information is UTC (Universal Time Coordiated) time information corresponding to a PTS value possessed by a first access unit among a plurality of media access units included in the media processing unit.

5. The apparatus of claim 3, wherein the media processing unit does not allocate the standard time information to every media processing unit, and upon allocation, adjusts a frequency of allocation of the standard time information depending on sync accuracy.

6. The apparatus of claim 1 wherein an NTP (Network Time Protocol) format is used to represent the standard time information.

7. The apparatus of claim 6, wherein the media processing unit varies the length of the NTP timestamp according to a resolution of the UTC time or sync accuracy when representing the standard time information in the NTP format.

8. The apparatus of claim 7, wherein the length of the NTP timestamp is at least any one of 32 bits, 48 bits, and 64 bits.

9. The apparatus of claim 1, wherein the MMT packet is transmitted in an in-band scheme.

10. The apparatus of claim 1, wherein whether the standard time information is generated is determined by judging whether a transmission environment is a hybrid transmission environment in which media streams are transmitted and received from different servers respectively belonging to different (heterogeneous) networks.

11. The apparatus of claim 1, wherein in an environment in which reference video information and additional video information generated by multi-view video coding are transmitted from different servers, respectively, the standard time information is included in an MMT packet including video information generated by the multi-view video coding and is transmitted.

12. The apparatus of claim 3, wherein the header or composition information of the media processing unit include information relating to whether to generate the standard time information, resolution information of the NTP timestamp for representing the standard time information and actual standard time information according to the resolution.

13. A method of transmitting a packet in an MMT (MPEG Media Transport) system, the method comprising:
an MMT packetizing step of generating an MMP packet by recording standard time information relating to a media access unit (AU) to provide sync of the media access unit; and
a transmitting step of transmitting the generated MMT packet to a receiver.

14. An apparatus of receiving a packet in an MMT (MPEG Media Transport) system, the apparatus comprising:
a receiving unit receiving an MMT packet from a sender; and
an MMT de-packetizing unit de-packetizing the MMT packet and syncing a media access unit (AU) included in the MMT packet based on standard time information relating to the media access unit to provide sync of the media access unit.

15. The apparatus of claim 14, wherein the MMT de-packetizing unit comprises:
a de-packetizing unit obtaining the standard time information included in a header or composition information (MMT-CI) of a media processing unit generated by de-packetizing the MMT packet; and
a syncing unit performing sync on the media access unit based on the obtained standard time information.

16. The apparatus of claim 14, further comprising a reproducing unit reproducing the synced media access unit.

17. The apparatus of claim 14, wherein the standard time information is UTC (Universal Time Coordiated) time information corresponding to a PTS value possessed by a first access unit among a plurality of media access units included in the media processing unit.

18. The apparatus of claim 17, wherein the header or composition information of the media processing unit include information relating to whether to generate the standard time information, resolution information of the NTP timestamp for representing the standard time information and actual standard time information according to the resolution.

19. The apparatus of claim 18, wherein the length of the NTP timestamp to represent the standard time information is at least any one of 32 bits, 48 bits, and 64 bits depending on sync accuracy or resolution of UTC time.

20. A method of receiving a packet in an MMT (MPEG Media Transport) system, the method comprising:
a receiving step receiving an MMT packet from a sender; and
an MMT de-packetizing step de-packetizing the MMT packet and syncing a media access unit (AU) included in the MMT packet based on standard time information relating to the media access unit to provide sync of the media access unit.
